(19) United States
(12) Patent Application Publication
(10) Pub. No.: US 2023/0312972 A1
(43) Pub. Date: Oct. 5, 2023

(54) COATING COMPOSITION WITH IMPROVED BLOCK AND HUMIDITY RESISTANCE, DIRECT TO METAL ADHERENCE AND LOW VOC CONTENT

(71) Applicant: Arkema Inc., King of Prussia, PA (US)

(72) Inventors: Yuting LI, King of Prussia, PA (US); Robert P. EISENHARDT, King of Prussia, PA (US); Wenjun WU, King of Prussia, PA (US); Michael DREWERY, King of Prussia, PA (US); Jeffrey P. ARDENT, King of Prussia, PA (US)

(21) Appl. No.: 18/022,766

(22) PCT Filed: Aug. 26, 2021
(86) PCT No.: PCT/US21/47755

§ 371 Date: Feb. 23, 2023

Related U.S. Application Data
(60) Provisional application No. 63/074,125, filed on Sep. 3, 2020.
(60) Provisional application No. 63/159,508, filed on Mar. 11, 2021.

(51) Int. Cl. C09D 147/00; C08F 220/10; C08F 2/44

(52) U.S. Cl. CPC C09D 147/00; C08F 220/10; C08F 2/44; C08F 2438/00

(57) ABSTRACT

Multi-stage polymeric particles are prepared as a water-borne emulsion, including a first-formed lower Tg soft stage and a second-formed higher Tg hard stage. The polymeric particles include, in both stages: one or more free radical polymerizable ethylenically unsaturated monomers; 0 to 3 wt % of free radical polymerizable surfactant monomer; 0 to 4 wt % of free radical poly-merizable monomer having a beta dicarbonyl functionality; 0 to 2 wt % of monomer selected from acrylamide, diacetone acrylamide, 2-hydroxyethyl (meth)acrylate, hydroxypropyl (meth)acrylates, and hydroxybutyl (meth)acrylates and mixtures thereof; 0-1.9 wt % of free radical polymerizable polyethylenically unsaturated monomers; 0.1 to 1.9% of free radical polymerizable monomer containing phosphorus acid or a salt thereof in the first stage, and 0.1 to 5 wt % of a free radical polymerizable monomer containing phosphorus acid or salt thereof in the second stage. Multi-stage polymeric-particle-based-resin is formulated into direct to metal coatings, having good block, corrosion and excellent humidity resistance.

### FIELD OF THE INVENTION

The invention relates to multistage polymeric particles useful in coating compositions having good block resistance, excellent humidity resistance, low VOC content, excellent direct-to-metal adherence, weatherability, as well as providing corrosion resistance to the unprimed metal substrate. The invention also relates to emulsion polymerization processes for forming these particles and coating compositions that contain them.

### BACKGROUND OF THE INVENTION

Direct-to metal coating compositions have to meet a challenging set of performance criteria to be successful.

Permissible VOC levels in coating compositions continues to decrease, due to more is stringent environmental regulations and increased consumer awareness. A major source of the VOC components in waterborne coating compositions are coalescing agents. A typical solution to reduce the need for coalescing agents, while maintaining good coalescence is to reduce the glass transition temperature (Tg) of the polymer particles in the coating compositions. Polymers having a low Tg, however, tend to reduce block resistance of the coating. Therefore a challenge for low volatile organic compound(VOC) containing waterborne coating systems is achieving good block resistance while at the same time coalescing adequately, both of which are a key performance requirements for many coating applications. The present invention discloses a method to improve the block resistance and humidity resistance of coating compositions, especially direct to metal coating compositions, while still keeping the VOC content low (less than 50 g/L). In addition, these coatings need to have good adhesion to the unprimed metal substrate, be humidity and corrosion resistant, and exhibit good weatherability when used in exterior coating applications.

U.S. Pat. Nos. 6,538,062, 7,285,590, 9,611,393, 10,273,378, 10,301,501, 10,563,084, US 2015/0031830 A1 and CN102030860 disclose polymeric particles having a hard-core and soft-shell structure.

U.S. Pat. Nos. 6,576,051, 6,710,161, 7,408,003, 8,318,848, 9,029,465, 9,273,221, 9,303,161, 9,447,215, 9,464,204, 9,469,760, 9,499,691, 9,932,431, 10,227,500, and 10,287,450 disclose polymeric particles including at least two acid monomers.

U.S. Pat. No. 4,654,397 discloses a process for the preparation of an aqueous polymer dispersion that has a low film forming temperature and forms films having a high block resistance, by multistage emulsion polymerization.

U.S. Pat. No. 5,185,387 discloses an aqueous dispersion having a minimum film forming temperature below 50° C.

U.S. Pat. No. 6,723,779 discloses a polymer particle having a core/shell structure.

U.S. Pat. No. 7,179,531 discloses a polymer composition comprising multistage polymer particles bearing phosphorus acid group, and both the first and second stage polymer Tg are in the range of −60° C. to 35° C.

U.S. Pat. No. 7,612,126 discloses a multistage polymer dispersion. The polymer dispersion is formulated with an anti-freeze agent.

U.S. Pat. Nos. 9,527,942 and 9,777,100 disclose a method to make two stage latex particles, with a hard phase formed first, then a soft phase. These polymers phase-inverse to form soft core/hard shell all-acrylic latex particles.

U.S. Pat. No. 9,920,194 discloses a composition comprising an aqueous dispersion of first and second acrylic-based polymer particles. The first polymer particles each includes a shell with a protuberating phosphorus acid functionalized core, and none of the second polymer particles includes a protuberating core.

U.S. Pat. No. 10,190,002 discloses an aqueous composition including aqueous multistage emulsion copolymer compositions including (a) one or more dihydrazide compounds in a total amount of from 0.5 to 4 wt. %, based on the total weight of composition solids, and (b) of one or more aqueous multistage emulsion copolymer containing phosphorous acid group.

U.S. Pat. No. 10,190,019 discloses a multilayer particle including a first soft layer and a second hard layer. The first stage polymer includes one or more carboxylic acid containing monomers.

WO 9833831 discloses an aqueous emulsion prepared in a multistage polymerization process, in which the multistage particles contain in polymerized form from 0.1 to 2 percent by weight of an addition polymerizable, ethylenically unsaturated monomer containing at least two carboxyl or carboxylate groups, such group include itaconic acid, fumaric acid, succinic acid, maleic acid or a mixture of two or more thereof.

EP 0522789 discloses a multistage emulsion polymer binder including at least first and second mutually incompatible polymers; and a photosensitive compound or composition.

EP 0609756 discloses a multistage polymer having at least two polymer domains. The polymer further includes a wet adhesion monomer, and a carboxylic acid monomer.

EP 0728154 discloses an aqueous polymer dispersion including at least one first polymer and at least one second polymer. The polymers are mutually incompatible. The second polymer has a Tg no more than 40° C. higher than that of the first polymer.

There remains a need for multi-stage polymeric particles capable of producing a direct-to-metal coating composition that has the desired combination of direct-to-metal adhesion, good block resistance, low VOC content, good humidity and corrosion resistance, and excellent outdoor weatherability provided by the multi-stage polymeric particles disclosed herein.

### SUMMARY OF THE INVENTION

The invention relates to multi-stage polymeric particles having a first-formed soft stage and a second-formed hard stage. The invention also provides for methods to form these particles and coating compositions that include them, especially coating compositions used in direct-to-metal applications.

The present invention thus provides for multi-stage polymeric particles. The polymeric particles include a) a first-formed soft stage including a first polymer and b) a second-formed hard stage comprising a second polymer. The first polymer has a theoretical Fox equation Tg of from 5 to -50° C. The second polymer has a theoretical Fox equation Tg of from 30° C. to 100° C. The multi-stage particles include, on a dry weight basis 10 wt % to 90 wt % of the first polymer, and 90 wt % to 10 wt % of the second polymer.

The first polymer includes, as polymerized units based on the dry weight of the first polymer:
i) one or more free radical polymerizable ethylenically unsaturated monomers,
ii) 0 to 3 wt % of a free radical polymerizable surfactant monomer,
iii) 0 to 4 wt % of a free radical polymerizable monomer having a beta dicarbonyl functionality,
iv) 0 to 2 wt % of a monomer selected from the group consisting of acrylamide, diacetone acrylamide, 2-hydroxyethyl (meth)acrylate, hydroxypropyl (meth)acrylates, hydroxybutyl (meth)acrylates, glycidyl methacrylate, 3-(methacryloyloxy)propyltrimethoxysilane, vinyltrimethoxysilane, and mixtures thereof;
v) 0.1 to 1.9 wt % of a free radical polymerizable monomer containing phosphorus acid or salt thereof;
vi) 0 to 1.9 wt % of a free radical polymerizable polyethylenically unsaturated monomer; and
less than 0.1 wt % of other acid-containing free-radical polymerizable monomers.

The second polymer, includes, as polymerized units based on the dry weight of the second polymer:
vii) one or more free radical polymerizable ethylenically unsaturated monomers,
viii) 0 to 3 wt % of a free radical polymerizable surfactant monomer,
ix) 0 to 4 wt % of a free radical polymerizable monomer having a beta dicarbonyl functionality,
x) 0 to 2 wt % of a monomer selected from the group consisting of acrylamide, diacetone acrylamide, 2-hydroxyethyl (meth)acrylate, hydroxypropyl (meth)acrylates, hydroxybutyl (meth)acrylates, glycidyl methacrylate, 3-(methacryloyloxy)propyltrimethoxysilane, vinyltrimethoxysilane, and mixtures thereof;
xi) 0.1 to 5 wt % of a free radical polymerizable monomer containing phosphorus acid or salt thereof, or 0.1 to 4 wt % a free radical polymerizable monomer containing phosphorus acid or salt thereof, or 0.1 to 3 wt % of a free radical polymerizable monomer containing phosphorus acid or salt thereof, or preferably 0.1 to 1.9 wt % of a free radical polymerizable monomer containing phosphorus acid or salt thereof;
xii) 0 to 1.9 wt % of a free radical polymerizable polyethylenically unsaturated monomer; and
less than 0.1 wt % of other acid-containing free-radical polymerizable monomers.

The invention also provides a method for forming multi-stage polymeric particles. The method comprises the steps of:
combining:
   i) one or more free radical polymerizable ethylenically unsaturated monomers,
   ii) 0 to 3 wt % of a free radical polymerizable surfactant monomer,
   iii) 0 to 4 wt % of a free radical polymerizable monomer having a beta dicarbonyl functionality,
   iv) 0 to 2 wt % of a monomer selected from the group consisting of acrylamide, diacetone acrylamide, 2-hydroxyethyl (meth)acrylate, hydroxypropyl (meth)acrylates, hydroxybutyl (meth)acrylates, glycidyl methacrylate, 3-(methacryloyloxy)propyltrimethoxysilane, vinyltrimethoxysilane and mixtures thereof;
   v) 0.1 to 1.9 wt % of a free radical polymerizable monomer containing phosphorus acid or salt thereof;
   vi) 0 to 1.9 wt % of a free radical polymerizable polyethylenically unsaturated monomer; and
   less than 0.1 wt % of other acid-containing free-radical polymerizable monomers,
   to form a first monomer mixture;
combining:
   vii) one or more free radical polymerizable ethylenically unsaturated monomers,
   viii) 0 to 3 wt % of a free radical polymerizable surfactant monomer,
   ix) 0 to 4 wt % of a free radical polymerizable monomer having a beta dicarbonyl functionality,
   x) 0 to 2 wt % of a monomer selected from the group consisting of acrylamide, diacetone acrylamide, 2-hydroxyethyl (meth)acrylate, hydroxypropyl (meth)acrylates, hydroxybutyl (meth)acrylates, glycidyl methacrylate, 3-(methacryloyloxy)propyltrimethoxysilane, vinyltrimethoxysilane and mixtures thereof;
   xi) 0.1 to 5 wt % of a free radical polymerizable monomer containing phosphorus acid or salt thereof, or 0.1 to 4 wt % a free radical polymerizable monomer containing phosphorus acid or salt thereof, or 0.1 to 3 wt % of a free radical polymerizable monomer containing phosphorus acid or salt thereof, or preferably 0.1 to 1.9 wt % of a free radical polymerizable monomer containing phosphorus acid or salt thereof;
   xii) 0 to 1.9 wt % of a free radical polymerizable polyethylenically unsaturated monomer and
no other acid-containing free-radical polymerizable monomers,
   to form a second monomer mixture;
feeding the first monomer mixture to a reactor vessel;
initiating a free radical polymerization, at a pH of from 2 to 9, preferably from 2 to 8, more preferably 2 to 7, of the first monomer mixture to form a first stage of the polymeric particles, the first-formed stage comprising a first polymer comprising the first monomer mixture as polymerized units;
feeding the second monomer mixture to the reactor vessel; and
polymerizing, at a pH of from 2 to 9, preferably from 2 to 8, more preferably 2 to 7, the second monomer mixture in the presence of the first-formed stage to form a second stage of the polymeric particles, the second stage comprising a second polymer comprising the second monomer mixture as polymerized units.

The second monomer mixture differs from the first monomer mixture in at least one of type or relative amount of polymerizable ethylenically unsaturated monomer. The weight of the first monomer mixture is from 10% to 90% of the total weight of the first monomer mixture and the second monomer mixture. The weight of the second monomer mixture is from 90% to 10% of the total weight of the first monomer mixture and the second monomer mixture. The polymeric particles comprise the first polymer and the second polymer. The first polymer has a theoretical Fox equation Tg of from −50° C. to 5° C. and the second polymer has a theoretical Fox equation Tg of from 30° C. to 100° C.

The invention also provides a coating composition including a coalescing agent and a waterborne emulsion including the multi-stage polymeric particles. The coating composition has a volatile organic compound content of less than 50 grams per liter and the coating composition has a minimum film forming temperature of less 15° C.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWING

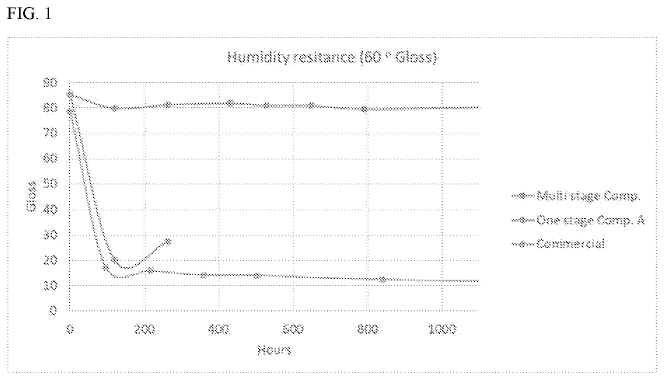

The FIG. 1 shows humidity resistance test results for certain embodiments of the invention compared to comparative examples and a commercial coating composition.

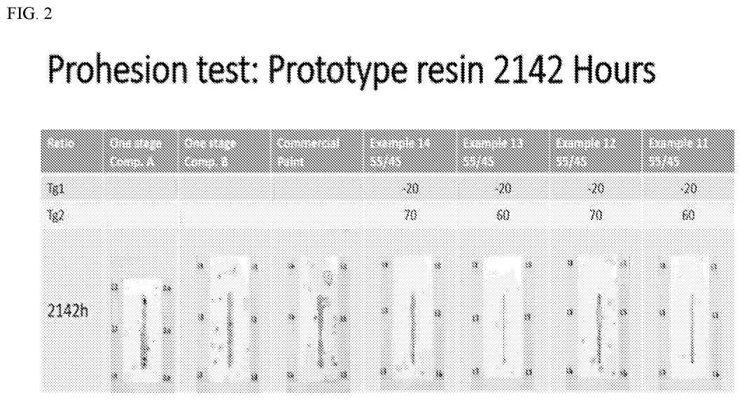

The FIG. 2 shows prohesion test results for certain embodiments of the invention compared to comparative examples and a commercial coating composition.

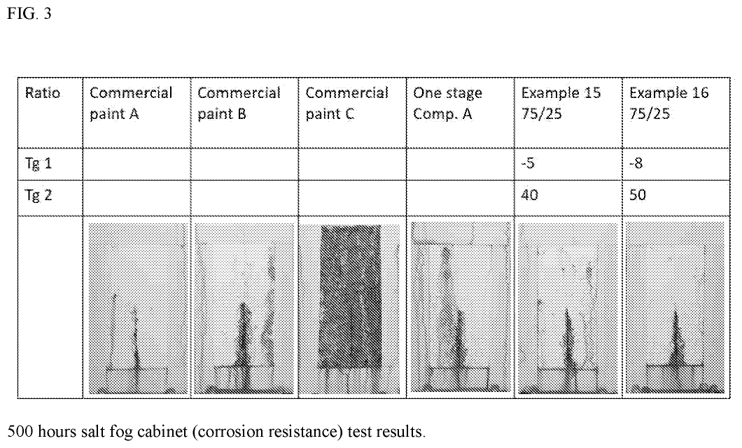

The FIG. 3 shows salt fog cabinet test results for certain embodiments of the invention compared to comparative examples and commercial coating compositions.

### DETAILED DESCRIPTION OF THE INVENTION

As used herein, the term “theoretical Fox Equation glass transition temperature” or “theoretical Fox equation Tg” refers to the estimated Tg of a polymer or copolymer calculated using the Fox equation. The Fox equation can be used to estimate the glass transition temperature of a random polymer or copolymer. The theoretical glass transition temperature Tg of a copolymer derived from monomers 1, 2 , . . . , i can be calculated according to equation (I):

$$\frac{1}{Tg} = {\sum }_{1}^{i} \frac{{w}_{i}}{{Tg}_{i}} \qquad ( I )$$

where wᵢ is the weight fraction of monomer i in the copolymer.

Unless otherwise indicated, all percentages herein are weight percentages.

The terms “layer” and “shell” and “stage” as used herein may be considered to be interchangeable.

The terms “paint” and “coating” as used herein may be considered to be interchangeable.

The term “direct to metal” adherence (or adhesion) as used herein means the coating was applied directly to a metal substrate. Additional surface treatment steps (i.e., wash primers, tie-coats, adhesion treatments, etc.) beyond basic cleaning (degreasing or solvent cleaning) preferably are not used and may be omitted altogether prior to applying the coating. The adhesion was then tested according to ASTM D-3359 (2017), method B (crosshatch adhesion).

The polymeric particles include a) a first-formed soft stage including a first polymer and b) a second-formed hard stage comprising a second polymer. The first (soft stage) polymer may have a theoretical Fox equation Tg of from 5° C. to −50° C., or from −10° C. to −40° C., or from −15 ° C. to −45° C., or from −20° C. to −40° C., or from 5° C. to −40° C. The second (hard stage) polymer may have a theoretical Fox equation Tg of from 30° C. to 100° C. , or from 35° C. to 90° C., or from 40° C. to 80° C., or from 45° C. to 70° C., or from 50° C. to 60° C. The polymeric particles may have two separate Tg's, or even three or more Tg's as measured by standard differential scanning calorimetry methods.

The multi-stage particles may include, on a dry weight basis 10wt % to 90wt % of the first polymer, and 90 wt % to 10 wt % of the second polymer. The multi-stage particles may include from 20 wt % to 80 wt %, 30 wt % to 70 wt %, 40 wt % to 60 wt %, or from 45 wt % to 55 wt % on a dry weight basis of the first polymer. The multi-stage particles may include from 80 wt % to 20 wt %, 70 wt % to 30 wt %, 60 wt % to 40 wt %, or from 55 wt % to 45 wt % on a dry weight basis of the second polymer. In one embodiment, the total of the weight % of the soft polymer phase and the weight % of the hard polymer phase is 100%.

The size of the polymer particles can vary. However, in various desirable embodiments of the invention, the particles have an average diameter of less than 350 nm, or less than 300 nm, or less than 250 nm, or less than 200 nm, or less than 150 nm (inclusive). Particle size and particle size distribution may be analyzed using Nanotrac UPA 150 (from Microtrac Inc.) to provide volume-averaged particle sizes based on dynamic light scattering techniques. Typically, the multi-stage particles may be approximately spherical in shape, although oblong, oval, teardrop or other shapes are also possible. In an embodiment of the invention, the soft polymer phase is an inner (core) phase within the polymer particles and the hard polymer phase is an outer (shell) phase.

### Free Radical Polymerizable Ethylenically Unsaturated Monomers i) and vii) and Free Radical Polymerizable Polyethylenically Unsaturated Monomers vi) and xii)

Non-limiting examples of suitable polymerizable ethylenically unsaturated monomers i) and vii) that may be used to form the first-formed soft stage and the second-formed hard stage of the multi-stage polymer particles include: branched and linear (C1-C20) alkyl or (C3-C20) alkenyl esters of (meth)acrylic acid, such as preferably methyl (meth)acrylate, ethyl (meth)acrylate, butyl (meth)acrylate, 2 ethylhexyl (meth)acrylate, hydroxyethyl (meth)acrylate, hydroxypropyl (meth)acrylate, benzyl (meth)acrylate, lauryl (meth)acrylate, oleyl (meth)acrylate, palmityl (meth)acrylate, stearyl (meth)acrylate and the like, vinyl aromatic monomers such as styrene, a-methyl styrene, p-methyl styrene, t-butyl styrene, or vinyltoluene, olefins such as ethylene, vinyl acetate, vinyl chloride, vinylidene chloride, (meth)acrylonitrile, and (meth)acrylamide, for example. Preferred monomers are methyl (meth)acrylate, 2 ethylhexyl (meth)acrylate, styrene, butyl (meth)acrylate, ethyl (meth)acrylate, benzyl (meth)acrylate, glycidyl methacrylate, 3-(methacryloyloxy)propyltrimethoxysilane, vinyltrimethoxysilane and mixtures thereof. More preferred monomers are styrene, methyl methacrylate, 2 ethylhexyl acrylate, butyl acrylate, and mixtures thereof.

In addition to the free-radical polymerizable ethylenically unsaturated monomers, the first-formed soft stage first polymer and the second-formed hard stage second polymer of the multi-stage polymeric particles may further include up to 1.9 wt % in each stage of free-radical polymerizable polyethylenically unsaturated monomer vi) and xii) as polymerized units. Either or both of the first-formed soft stage polymer and the second-formed hard stage polymer may include from 0.0 to 1.9 wt % of a free-radical polymerizable polyethylenically unsaturated monomer. In some embodiments, the amount of these free-radical polymerizable polyethylenically unsaturated monomer in either or both of the first polymer or the second polymer may be from 0.1 to 1.9 wt %, or from 0.2 to 1.9 wt %, or from 0.3 to 1.9 wt %, or from 0.4 to 1.9 wt %, or from 0.5 to 1.9 wt %, or from 0.6 to 1.9 wt %, or from 0.7 to 1.9 wt %, or from 0.8 to 1.9 wt %, or from 0.9 to 1.9 wt %, or from 1.0 to 1.9 wt %, or from 1.1 to 1.9 wt %, 1.2 to 1.9 wt %, or from 1.3 to 1.9 wt %, or from 1.4 to 1.9 wt %, or from 1.5 to 1.9 wt %, or from 1.6 to 1.9 wt %, or from 1.7 to 1.9 wt %, or from 1.8 to 1.9 wt %, or from 1.85 to 1.9 wt % on a dry weight basis. In some embodiments, the amount of these free-radical polymerizable polyethylically unsaturated monomer in either or both of the first polymer or the second polymer may be from 0.2 to 1 wt %, or from 0.2 to 0.9 wt %, or from 0.2 to 0.8 wt %, or from 0.2 to 0.7 wt %, or from 0.2 to 0.6 wt %, or from 0.2 to 0.5 wt %, or from 0.2 to 0.4 wt % or from 0.2 to 0.3 wt % or from 0.1 to 0.5 wt %.

Non-limiting examples of suitable polyethylenically unsaturated monomers include co-monomers containing at least two polymerizable vinylidene groups such as α,β- ethylenically unsaturated monocarboxylic acid esters of polyhydric alcohols containing 2-6 ester groups. Such co-monomers include alkylene glycol diacrylates and dimethacrylates, such as for example, ethylene glycol diacrylate; ethylene glycol dimethacrylate; 1,3-butylene glycol diacrylate; 1,4-butylene glycol diacrylate; 1,6-hexanediol diacrylate; propylene glycol diacrylate and triethylene glycol dimethylacrylate; 1,3-glycerol dimethacrylate; 1,1,1-trimethylol propane dimethacrylate; 1,1,1-trimethylol ethane diacrylate; pentaerythritol trimethacrylate; 1,2,6-hexane triacrylate; sorbitol pentamethacrylate; methylene bis-acrylamide; methylene bis-methacrylamide; divinyl benzene; vinyl methacrylate; vinyl crotonate; vinyl acrylate; vinyl acetylene; trivinyl benzene; triallyl cyanurate; divinyl acetylene; divinyl ethane; divinyl sulfide; divinyl ether; divinyl sulfone; diallyl cyanamide; ethylene glycol divinyl ether; diallyl phthalate; divinyl dimethyl silane; glycerol trivinyl ether; divinyl adipate; dicyclopentenyl (meth)acrylates; dicyclopentenyloxy (meth)acrylates; unsaturated esters of glycol monodicyclopentenyl ethers; allyl esters of α,β-unsaturated mono- and dicarboxylic acids having terminal ethylenic unsaturation including allyl methacrylate, allyl acrylate, diallyl maleate, diallyl fumarate, diallyl itaconate and the like. According to some embodiments, preferred monomers are ethylene glycol diacrylate; ethylene glycol dimethacrylate; 1,6-hexanediol diacrylate; divinyl benzene; vinyl methacrylate; vinyl acrylate; allyl methacrylate; allyl acrylate, and mixtures thereof. According to some embodiments, most preferred monomers are allyl methacrylate, divinyl benzene and 1,6-hexanediol diacrylate, and mixtures thereof.

Mixtures of any or all of the above free-radical polymerizable monomers may be included in either or both of the first and second polymers.

The one or more free radical polymerizable ethylenically unsaturated monomers in the first polymer may be selected from the group consisting of one or more alkyl(meth)acrylates, styrene, and mixtures thereof. The one or more free radical polymerizable ethylenically unsaturated monomers in the second polymer are selected from the group consisting of one or more alkyl(meth)acrylates, styrene, and mixtures thereof.

According to some embodiments, preferred monomers are methyl (meth)acrylate, 2 ethylhexyl (meth)acrylate, styrene, butyl (meth)acrylate, ethyl (meth)acrylate, benzyl (meth)acrylate and mixtures thereof. According to some embodiments, most preferred monomers are styrene, methyl methacrylate, 2 ethylhexyl acrylate, butyl acrylate, butyl methacrylate and mixtures thereof.

### Free Radical Polymerizable Surfactant Monomers ii) and viii)

Either or both of the first-formed soft stage polymer and the second-formed hard stage polymer may include from 0-3 wt % of a free-radical polymerizable surfactant monomer. Such surfactant monomers may be anionic, cationic or non-ionic. Preferably, the polymerizable surfactant monomers are anionic. In some embodiments, the amount of the free-radical polymerizable surfactant monomer in either or both of the first polymer or the second polymer may be, up to 3 wt %, or from 0.01 to 3 wt %, or from 0.05 to 3 wt %, or from 0.1 to 3 wt %, or from 0.5 to 3 wt %, or from 1 to 3 wt %, or from 2 to 3 wt % on a dry weight basis.

Non-limiting examples of suitable free radical polymerizable surfactant monomers are selected from monomers according to Formulas II, III, IV, including mixtures thereof, where Formula II is:

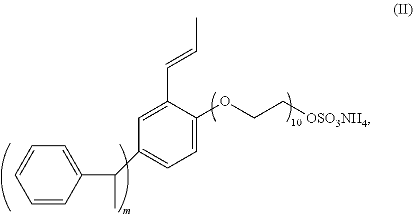

where m is an integer from 1 to 30,
Formula III is:

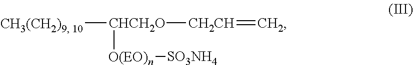

where n is an integer from 1 to 30,
and Formula IV is:

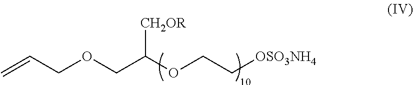

where R is a branched C10 alkyl group or bicycloheptane.

According to some embodiments, Formulas II and IV are preferred. Most preferred is Formula II.

### Free Radical Polymerizable Monomer Having A Beta Dicarbonyl Functionality iii) and ix)

Either or both of the first-formed soft stage polymer and the second-formed hard stage polymer may include from 0-4 wt % of a free-radical polymerizable monomer having a beta dicarbonyl functionality. In some embodiments, the amount of the free-radical polymerizable monomer having a beta dicarbonyl functionality in either or both of the first polymer or the second polymer may be from 0.01 to 4 wt %, or from 0.05 to 4 wt %, or from 0.1 to 4 wt %, or from 0.5 to 4 wt %, or from 1 to 4 wt %, or from 2 to 4 wt %, or from 3 to 4 wt % on a dry weight basis.

Non-limiting examples of these free-radical polymerizable monomers having a beta dicarbonyl functionality may be selected from the group consisting of acetoacetoxyalkyl(meth)acrylate, 2-acetoacetoxyethyl (meth)acrylate, 3-acetoacetoxypropyl (meth)acrylate, 4-acetoacetoxybutyl (meth)acrylate, 2-cyanoacetoxyethyl (meth)acrylate, 3-cyanoacetoxypropyl (meth)acrylate, 4-cyanoacetoxybutyl (meth)acrylate, N-(2-acetoacetoxyethyl) (meth)acrylamide, allyl acetoacetate, 2,3-di(acetoacetoxy)propyl (meth)acrylate, vinyl acetoacetate, and combinations thereof. According to some embodiments preferred monomers are 2-acetoacetoxyethyl (meth)acrylate, 3-acetoacetoxypropyl (meth)acrylate, allyl acetoacetate, and combinations thereof. According to an embodiment, the most preferred of these monomers is 2-acetoacetoxyethyl methacrylate.

### Acrylamide and the Like; Monomers iv) and x)

Either or both of the first-formed soft stage polymer and the second-formed hard stage polymer may include from 0-2 wt % of a free-radical polymerizable monomer selected from the group consisting of acrylamide, diacetone acrylamide, 2-hydroxyethyl (meth)acrylate, hydroxypropyl (meth)acrylates, and hydroxybutyl (meth)acrylates and mixtures thereof. In some embodiments, the amount of these free-radical polymerizable monomers in either or both of the first polymer or the second polymer may be from 0.01 to 2 wt %, or from 0.05 to 2 wt %, or from 0.1 to 2 wt %, or from 0.5 to 2 wt %, or from 1 to 2 wt %, or from 1.5 to 2 wt % on a dry weight basis. In some embodiments, the preferred monomers are acrylamide, 2-hydroxyethyl (meth)acrylate, hydroxypropyl (meth)acrylates, glycidyl methacrylate, 3-(methacryloyloxy)propyltrimethoxysilane, vinyltrimethoxysilane, and combinations thereof. According to some embodiments, most preferred are acrylamide, 2-hydroxyethyl (meth)acrylate, and combinations thereof.

### Free Radical Polymerizable Monomer Containing Phosphorus Acid or Salt Thereof v) and xi)

Either or both of the first-formed soft stage polymer and the second-formed hard stage polymer may include from 0.1 to 5 wt % of a free radical polymerizable monomer containing phosphorus acid or salt thereof, or 0.1 to 4 wt % a free radical polymerizable monomer containing phosphorus acid or salt thereof, or 0.1 to 3 wt % of a free radical polymerizable monomer containing phosphorus acid or salt thereof, or preferably 0.1 to 1.9 wt % of a free-radical polymerizable monomer containing phosphorus acid or salt thereof. In some embodiments, the amount of these free-radical polymerizable monomers containing phosphorus acid or salts thereof in either or both of the first polymer or the second polymer may be from 0.1 to 1.9 wt %, or from 0.2 to 1.9 wt %, or from 0.3 to 1.9 wt %, or from 0.4 to 1.9 wt %, or from 0.5 to 1.9 wt %, or from 0.6 to 1.9 wt %, or from 0.7 to 1.9 wt %, or from 0.8 to 1.9 wt %, or from 0.9 to 1.9 wt %, or from 1.0 to 1.9 wt %, or from 1.1 to 1.9 wt %, 1.2 to 1.9 wt %, or from 1.3 to 1.9 wt %, or from 1.4 to 1.9 wt %, or from 1.5 to 1.9 wt %, or from 1.6 to 1.9 wt %, or from 1.7 to 1.9 wt %, or from 1.8 to 1.9 wt %, or from 1.85 to 1.9 wt % on a dry weight basis. In some embodiments, the amount of these free-radical polymerizable monomers containing phosphorus acid or salts therefor in either or both of the first or second polymer may be from 0.1 to 5 wt %, or from 0.2 to 5 wt %, or from 0.3 to 5wt %, or from 0.4 to 5 wt %, or from 0.5 to 5 wt %, or from 0.6 to 5 wt %, or from 0.7 to 5 wt %, or from 0.8 to 5 wt %, or from 0.9 to 5 wt %, or from 1 to 5 wt %, or from 1.5 to 5 wt %, 2 to 5 wt %, or from 2.5 to 5 wt %, or from 3 to 5 wt %, or from 3.5 to wt %, or from 4 to 5 wt %, or from 4.5 to 5 wt % on a dry weight basis.

The free-radical polymerizable monomer containing phosphorus acid or salts thereof may conform to Formula I:

CH₂═C(R¹)—C(═O)—O—[X—O]ₙ—P(═O)(OY)₂ (I)
where R¹ is H or CH₃, each X is independently —(CH₂)₂—, —CH₂CH(CH₃)—, —CH(CH₃)CH₂—, —(CH₂)₂—O—CH₂CH(CH₃)—, or —(CH₂)₂—O—CH(CH₃)CH₂—, and mixtures thereof, each Y is independently H, ammonium, or an alkali metal, and n is an integer from 1 to 30 (or 2 to 25 or 3 to 20). Mixtures of different oxyalkylene-containing (meth)acrylates may be utilized.

The oxyalkylene-containing (meth)acrylate described by Formula (I) thus may be a polyethylene glycol mono(meth)acrylate and/or a phosphate ester of a polyethylene glycol mono(meth)acrylate. Such monomers are well known in the art and may be readily obtained from commercial sources. For example, the phosphate esters of polyethylene glycol mono(methacrylate) sold by Solvay under the trade name Sipomer® PAM may be utilized. Monomers corresponding to Formula (I) may be prepared by reacting epoxides such as ethylene oxide and/or propylene oxide with (meth)acrylic acid and then optionally reacting the terminal hydroxyl group to form an alkyl ether group. It is understood that monomers prepared by such a method may be mixtures of compounds having different n values. Preferred are: poly(oxy-1,2-ethanediyl), α-(2-methyl-1-oxo-2-propen-1-yl)-ω-(phosphonooxy) (Sipomer® PAM 100 CAS no. 35705-94-3); phosphate esters of polypropyleneglycol monomethacrylate (Sipomer® PAM200); phosphate esters of polypropyleneglycol monoacrylate (Sipomer® PAM 300), ammonia neutralized phosphate esters of polypropyleneglycol monomethacrylate (Sipomer® 600); esters of 2-hydroxyethyl methacrylate and phophoric acid (Sipomer® PAM4000, CAS no.: 52628-03-02); and combinations thereof.

### No Other Acid-Containing Monomers Are Included

In some embodiments neither the first-formed soft phase polymer nor the second-formed hard-phase polymer contain any other free-radical polymerizable monoethylenically unsaturated monomers containing acid-functionality beyond what may be incidentally included in the polymers as contaminants, for example. “Not including” should be understood as meaning that these monomer are not intentionally added, even though there may be a residual amount present. For example, the soft phase polymer and/or the hard phase polymer may include less than 1% wt %, less than 0.9% wt %, less than 0.8 wt %, less than 0.7% wt %, less than 0.6 wt %, less than 0.5% wt %, less than 0.4 wt %, less than 0.3% wt %, less than 0.2 wt %, less than 0.1 wt %, less than 0.09% wt %, less than 0.08 wt %, less than 0.07% wt %, less than 0.06 wt %, less than 0.05% wt %, less than 0.04 wt %, less than 0.03% wt %, less than 0.02 wt %, less than 0.01 wt %, less than 0.009% wt %, less than 0.008 wt %, less than 0.007% wt %, less than 0.006 wt %, less than 0.005% wt %, less than 0.004 wt %, less than 0.003% wt %, less than 0.002 wt %, less than 0.001 wt %, by weight of the total weight of the soft phase polymer or the hard phase polymer, respectively, of any other free-radical polymerizable monoethylenically unsaturated monomers containing acid-functionality.

Non-limiting examples of such acid-functional monomers are those containing at least one carboxylic acid group including acrylic acid, methacrylic acid, acryloxypropionic acid, (meth)acryloxypropionic acid, itaconic acid, aconitic acid, maleic acid or anhydride, fumaric acid, crotonic acid, monomethyl maleate, monomethyl fumarate, monomethyl itaconate and salts thereof, monomers containing at least one sulfuric acid group including sulfoethyl methacrylate, sulfopropyl methacrylate, styrene sulfonic acid, vinyl sulfonic acid, 2-(meth)acrylamido-2-methyl propanesulfonic acid, as well as salts thereof, and the like.

### Wet Adhesion Monomers Are Not Included in Some Embodiments

In some embodiments, neither the first-formed soft phase polymer nor the second-formed hard-phase polymer contain any other free-radical polymerizable wet adhesion monomers containing acid-functionality beyond what may be incidentally included in the polymers as contaminants, for example. “Not including” should be understood as meaning that these wet adhesion monomers are not intentionally added, even though there may be a residual amount present. For example, the soft phase polymer and/or the hard phase polymer may include less than 1% wt %, less than 0.9% wt %, less than 0.8 wt %, less than 0.7% wt %, less than 0.6 wt %, less than 0.5% wt %, less than 0.4 wt %, less than 0.3% wt %, less than 0.2 wt %, less than 0.1 wt %, less than 0.09% wt %, less than 0.08 wt %, less than 0.07% wt %, less than 0.06 wt %, less than 0.05% wt %, less than 0.04 wt %, less than 0.03% wt %, less than 0.02 wt %, less than 0.01 wt %, less than 0.009% wt %, less than 0.008 wt %, less than 0.007% wt %, less than 0.006 wt %, less than 0.005% wt %, less than 0.004 wt %, less than 0.003% wt %, less than 0.002 wt %, less than 0.001 wt %, by weight of the total weight of the soft phase polymer or the hard phase polymer, respectively, of any other free-radical polymerizable monoethylenically unsaturated wet adhesion monomers.

Neither the first-formed soft phase polymer nor the second-formed hard-phase polymer contain any other free-radical polymerizable monomers known in the art as “wet-adhesion monomers.” Non-limiting examples of such monomers are well known in the art and include ethylenically unsaturated amino-, urea- and ureido-functionalized monomers such as aminoethyl acrylate and methacrylate, dimethylaminopropyl acrylate and methacrylate, 3-dimethylamino- 2,2-dimethylpropyl-1-acrylate and methacrylate, 2-N-morpholinoethyl acrylate and methacrylate, 2-N-piperidinoethyl acrylate and methacrylate, N-(3-dimethylaminopropyl) acrylamide and methacrylamide, N-(3-dimethylamino-2,2-dimethylpropyl) acrylamide and methacrylamide, N-dimethylaminomethyl acrylamide and methacrylamide, N-dimethylaminomethyl acrylamide and methacrylamide, N-(4-morpholino-methyl) acrylamide and methacrylamide, vinylimidazole, vinylpyrrolidone, N-(2-methacryloyloxyethyl) ethylene urea, N-(2-methacryloxyacetamidoethyl)-N,N′-ethyleneurea, allylalkyl ethylene urea, N-methacrylamidomethyl urea, N-methacryoyl urea, 2-(1-imidazolyl) ethyl methacrylate, N-(methacrylamido)ethyl ethylene urea (Sipomer® WAM II, Rhodia) and allyl ureido wet adhesion monomer (Sipomer® WAM, Rhodia).

### Methods for Forming the Multi-Stage Polymeric Particles

The invention also provides a method for forming multi-stage polymeric particles. The method comprises the steps of:
Combining:
   i) one or more free radical polymerizable ethylenically unsaturated monomers,
   ii) 0 to 3 wt % of a free radical polymerizable surfactant monomer,
   iii) 0 to 4 wt % of a free radical polymerizable monomer having a beta dicarbonyl functionality,
   iv) 0 to 2 wt % of a monomer selected from the group consisting of acrylamide, diacetone acrylamide, 2-hydroxyethyl (meth)acrylate, hydroxypropyl (meth)acrylates, and hydroxybutyl (meth)acrylates, glycidyl methacrylate, 3-(methacryloyloxy)propyltrimethoxysilane, vinyltrimethoxysilane, and mixtures thereof;
   v) 0.1 to 1.9 wt % of a free radical polymerizable monomer containing phosphorus acid or salt thereof;
   vi) 0 to 1.9 wt % of a free radical polymerizable polyethylenically unsaturated monomer; and
   less than 0.1 wt % of other acid-containing free-radical polymerizable monomers,
   to form a first monomer mixture. The first monomer mixture may further include one or more surfactants. Anionic, cationic and non-ionic surfactants such as are known and used in the art for emulsion polymerizations are all suitable. The first monomer mixture may further comprise 0 to 1.9 wt % of a free radical polymerizable polyethylenically unsaturated monomer.
Combining:
   vii) one or more free radical polymerizable ethylenically unsaturated monomers,
   viii) 0 to 3 wt % of a free radical polymerizable surfactant monomer,
   ix) 0 to 4 wt % of a free radical polymerizable monomer having a beta dicarbonyl functionality,
   x) 0 to 2 wt % of a monomer selected from the group consisting of acrylamide, diacetone acrylamide, 2-hydroxyethyl (meth)acrylate, hydroxypropyl (meth)acrylates, and hydroxybutyl (meth)acrylates, glycidyl methacrylate, 3-(methacryloyloxy)propyltrimethoxysilane, vinyltrimethoxysilane, and mixtures thereof;
   xi) 0.1 to 5 wt % of a free radical polymerizable monomer containing phosphorus acid or salt thereof, or 0.1 to 4 wt % a free radical polymerizable monomer containing phosphorus acid or salt thereof, or 0.1 to 3 wt % of a free radical polymerizable monomer containing phosphorus acid or salt thereof, or preferably 0.1 to 1.9 wt % of a free radical polymerizable monomer containing phosphorus acid or salt thereof;
   xii) 0 to 1.9 wt % of a free radical polymerizable polyethylenically unsaturated monomer; and
less than 0.1 wt % of other acid-containing free-radical polymerizable monomers,
   to form a second monomer mixture. The second monomer mixture may further include one or more surfactants. Anionic, cationic and non-ionic surfactants such as are known and used in the art for emulsion polymerizations are all suitable. The second monomer mixture may further comprise 0 to 1.9 wt % of a free radical polymerizable polyethylenically unsaturated monomer.
Feeding the first monomer mixture to a reactor vessel.
Initiating a free radical polymerization, at a pH of from at a pH of from 2 to 9, preferably from 2 to 8, more preferably 2 to 7 of the first monomer mixture to form a first stage of the polymeric particles, the first-formed stage comprising a first polymer comprising the first monomer mixture as polymerized units. The pH may be from 2-7; or from 2-6; or from 2-5.
Feeding the second monomer mixture to the reactor vessel.

Polymerizing, at a pH of from 2 to 9, preferably from 2 to 8, preferably from 2 to 7, the second monomer mixture in the presence of the first-formed stage to form a second stage of the polymeric particles, the second stage comprising a second polymer comprising the second monomer mixture as polymerized units. The pH may be from 2-7, or from 2-6, or from 2-5.

The second monomer mixture differs from the first monomer mixture in at least one of type or relative amount of polymerizable ethylenically unsaturated monomer. The weight of the first monomer mixture is from 10% to 90% of the total weight of the first monomer mixture and the second monomer mixture. The weight of the first monomer mixture may be from 20 wt % to 80 wt %, 30 wt % to 70 wt %, 40 wt % to 60 wt %, or from 45 wt % to 55 wt % of the total weight of the first monomer mixture and the second monomer mixture. The weight of the second monomer mixture is from 90% to 10% of the total weight of the first monomer mixture and the second monomer mixture. The weight of the second monomer mixture may be from 80 wt % to 20 wt %, 70 wt % to 30 wt %, 60 wt % to 40 wt %, or from 55 wt % to 45 wt % of the total weight of the first monomer mixture and the second monomer mixture. The polymeric particles comprise the first polymer and the second polymer. The first polymer may have a theoretical Fox equation Tg of from −50° C. to 5° C. and the second polymer may have a theoretical Fox equation Tg of from 30° C. to 100° C.

The free radical initiators suitable for the polymerization of the monomers used to prepare the multi-stage emulsion polymer particles as described herein may be any water soluble initiator suitable for aqueous emulsion polymerization. Examples of free radical initiators suitable for the preparation of the multi-stage emulsion polymer particles of the present application include hydrogen peroxide, tert-butyl peroxide, alkali metal persulfates such as sodium, potassium and lithium persulfate, ammonium persulfate, and mixtures of such initiators with a reducing agent. The amount of initiator may be, for example, from 0.01 to 3 percent by weight, based on the total amount of monomer.

In some embodiments, a redox polymerization initiator system may be used. In a redox free radical initiation system, a reducing agent may be used in conjunction with an oxidant. Reducing agents suitable for the aqueous emulsion polymerization include sulfites (e.g., alkali metal metabisulfite, hydrosulfite, and hyposulfite). In some embodiments, sugars (such as ascorbic acid and isoascorbic acid or an alkali metal (iso)ascorbate salt) might also be a suitable reducing agent for the aqueous emulsion polymerization. In a redox system, the amount of reducing agent may be, for example, from 0.01 to 3 percent by weight based on the total amount of monomer.

Oxidizing agents include, for example, for example, hydrogen peroxide and ammonium or alkali metal persulfates, perborates, peracetates, peroxides, and percarbonates and a water-insoluble oxidizing agent such as, for example, benzoyl peroxide, lauryl peroxide, t-butyl peroxide, t-butyl hydroperoxide, 2,2′-azobisisobutyronitrile, t-amyl hydroperoxide, t-butyl peroxyneodecanoate, and t-butyl peroxypivalate. The amount of oxidizing agent may be, for example, from 0.01 to 3 percent by weight, based on the total amount of monomer.

The free radical polymerization temperature typically is in the range of about 10° C. to 100° C. In the case of the persulfate systems, the temperature may be in the range of about 60° C. to about 100° C. In the redox system, the temperature may be in the range of about 30° C. to about 100° C., in the range of about 30° C. to about 60° C., or in the range of about 30° C. to about 45° C. The type and amount of initiator may be the same or different in the various stages of the multi-stage polymerization.

One or more nonionic or ionic (e.g., cationic, anionic) emulsifiers, or surfactants, may be used, either alone or together, during either or preferably both polymerization of the first soft phase monomer mixture and polymerization second hard phase monomer mixture in order to emulsify the monomers and/or to keep the resulting polymer particles in dispersed or emulsified form. Examples of suitable nonionic emulsifiers include tert-octylphenoxyethylpoly-ethoxyethanol, dodecyloxypolyethoxyethanol, nonylphenoxyethyl-polyethoxyethanol, polyethylene glycol 2000 monooleate, ethoxylated castor oil, fluorinated alkyl esters and alkoxylates, polyoxyethylene sorbitan monolaurate, sucrose monococoate, di(2-butyl)phenoxypolyethoxyethanol, hydroxyethylcellulosepolybutyl acrylate graft copolymer, dimethyl silicone polyalkylene oxide graft copolymer, poly(ethylene oxide)poly(butyl acrylate) block copolymer, block copolymers of propylene oxide and ethylene oxide, 2,4,7,9-tetramethyl-5-decyne-4,7-diol ethoxylated with 30 moles of ethylene oxide, N-polyoxyethylenelauramide, N lauryl-N-polyoxyethyleneamine and polyethylene glycol dodecyl thioether. Examples of suitable ionic emulsifiers include sodium lauryl sulfate, sodium alpha olefin sulfonate, sodium dodecylbenzenesulfonate, potassium stearate, sodium dioctyl sulfosuccinate, sodium dodecyldiphenyloxide disulfonate, nonylphenoxyethylpolyethoxyethyl sulfate ammonium salt, sodium styrene sulfonate, sodium dodecyl allyl sulfosuccinate, palmitic acid, palmitoleic acid, stearic acid, oleic acid, linoleic acid, linolenic acid, mixtures of fatty acids (e.g., linseed oil fatty acid), sodium or ammonium salts of phosphate esters of ethoxylated nonylphenol, sodium octoxynol-3-sulfonate, sodium cocoyl sarcocinate, sodium 1-alkoxy-2-hydroxypropyl sulfonate, sodium α-olefin (C14-C16)sulfonate, sulfates of hydroxyalkanols, tetrasodium N-(1,2-dicarboxy ethyl)-N-octadecylsulfosuccinamate, disodium N-octadecylsulfosuccinamate, disodium alkylamido polyethoxy sulfosuccinate, disodium ethoxylated nonylphenol half ester of sulfosuccinic acid, the sodium salt of tert-octylphenoxyethoxypolyethoxyethyl sulfate, sodium or ammonium salt of fatty alcohol polyglycol ether sulfate, and sodium or ammonium salt of fatty alcohol ether sulfate.

The one or more emulsifiers or surfactants are generally used at a level of from 0 to 3 percent based on the weight of the monomers. The one or more emulsifiers or surfactants can be added prior to the addition of any monomer charge, during or after the addition of a monomer charge or a combination thereof.

### Coating Compositions; Other Additives

The multi-stage polymeric particles described herein may be used in coating compositions. These coating compositions are especially suitable for direct to metal applications. Such coating compositions may be paints, primers, base coats, clear coats and varnishes. The coating compositions may be topcoat or finish coats that are applied directly to a metal surface. A top coat or finish coat may be applied to the direct to meal coating after it is applied to the metal surface. The topcoat/finish coat can be the same or different from the basecoat or primer. As used here, the term “direct to metal” means the coating composition may be applied directly to a metal substrate. Additional surface treatment steps (i.e., wash primers, tie-coats, adhesion treatments, etc.) beyond basic cleaning (degreasing or solvent cleaning) are preferably not used prior to applying a direct to metal coating composition. These compositions can contain other additives such as are known and used in the art. Non-limiting examples of such additives are opacifiers, pigments, tints, emulsifiers, rheology control additives, driers, etc. The coating formulations, may be modified by the addition of one or more additives, including without limitation additional polymers, metal driers, pigments or colorants, fillers, dispersants or surfactants, plasticizers, defoamers, thickeners, biocides, solvents , rheology modifiers, wetting or spreading agents, leveling agents, conductive additives, thermal insulating filler, adhesion promoters, anti-blocking agents, anti-cratering agents or anti-crawling agents, corrosion inhibitors, anti-static agents, flame retardants, optical brighteners, UV absorbers or other light stabilizers, chelating agents, cross-linking agents, flattening agents, flocculants, humectants, insecticides, lubricants, odorants, oils, waxes or anti-slip aids, soil repellants, and stain resistant agents.

The coating compositions preferably are those known in the art as low-VOC coatings, i.e. coatings containing low levels of volatile organic components, such as those used to improve the coalescing properties of the coating compositions.

### Methods of Using Coating Compositions that Comprise the Multi-Stage Polymeric Particles

The product formulations may be applied by conventional techniques, such as dipping, brushing, flowing, or spraying to name a few, onto a variety of substrate surfaces. The substrates may include without limitation, unprimed metal, especially unprimed ferrous or unprimed galvanized metal surfaces, wood, fabricated wood, paper, cardboard, textiles, synthetic resins, ceramics, ferrous metals, non-ferrous metals, stone, concrete, plaster, and the like.

The product formulation may be used in an indoor or outdoor application. Outdoor applications may include, without limitation, metal coating applications. Additional outdoor applications may include, but not be limited to, rail car coating, agricultural machinery coating, automobile parts coating, wood coatings, log cabin coatings and deck stains. The polymer composition in the product formulation formed thereof may provide coatings for automotive, industrial, construction and residential housing applications, including for example, without limitation, wood stains, porch and deck stains, glossy top coats, traffic paints, general metal coatings, kitchen cabinetry coatings, automobile refinish, lawn and garden equipment coatings, bus and truck top coatings, gloss trim enamels, metal primers, light duty maintenance coatings, furniture coatings, stain blocking coatings, appliance coatings, dumpster coatings, heavy duty equipment coatings, industrial equipment coatings, paints, primers, base coats, clear coats and varnishes, topcoat or finish coats, and sash and trim enamels. The product formulations may also be useful for adhesive and ink applications.

### Test Methods

### Glass Transition Temperature

The glass transition temperature (Tg) of the polymers are determined by differential scanning calorimetry (DSC) with TA Instruments DSC Q 2000.

Method: Non Modulated Standard Method

### Analysis

Equilibrate at 60° C.
Isothermal Hold for 5 min
Ramp 10° C./min to −65° C.
Equilibrate @ −65° C.
Isothermal Hold for 1 min
Ramp 10° C./min to 140° C.
Calibration Method: Indium

### Particle Size

Particle size and particle size distribution are analyzed with dynamic light scattering using a Nanotrac UPA 150 Particle Size Analyzer and 0.463 μm polystyrene standards.

Block Resistance: Scale of 0 to 10, where 10 is the best.

Room Temperature (RT) Block Resistance: The test paints are drawn down on a Leneta 3B Opacity chart (available from The Leneta Co., Mahwah, N. J.) using a 3 mil Bird drawdown bar. As used herein, a “mil” refers to one thousandth of an inch or 25.4 microns (μm). The films for room temperature (RT) block resistance are dried in a constant temperature, constant humidity (CT/CH) laboratory at 22° C. and 40 to 60 percent relative humidity for 1 day and for 7 days. Two square paint strips of about 1.5 inches square (about 3.8 cm²) are placed together with paint film against paint film under 1 pound (454 grams) of weight in the CT/CH laboratory. After 24 hours, the strips are separated and evaluated according to the ASTM D-4946 (2017) ratings. The test is repeated three times and the average value is reported.

Elevated Temperature (ET) Block Resistance: The paint strips are dried in CT/CH Lab for 1 day and for 7 days. The paint strips (film against film) are then placed into a 120 degree Fahrenheit (° F.) (49° C.) oven under 1 pound (454 grams) of weight for one hour for an elevated temperature (ET) block test. The films are allowed to cool at room temperature for 30 minutes before the ratings of film separation are given. Results are reported on a scale of 0 to 10, where 10 is the best.

### Humidity Resistance

Humidity resistance was conducted according to ASTM D4585. Films were cast onto treated aluminum panels with a 7-mil (18 μm) gap square applicator blade, resulting in a 3.5 mil (9 μm) wet film and a final Dry Film Thickness (DFT) of 1.5 mil (38 microns) +/−0.1 mil (2.54 μm). The films were allowed to cure for 7 days and then placed in an enclosed chamber containing a heated, saturated mixture of air and water vapor. The temperature of the chamber is maintained at 122° F. (50° C.). The film gloss were measured at regular intervals.

### Corrosion Resistance (Prohesion Test)

Corrosion resistance was conducted in accordance with ASTM G85 Annex 5. Films were cast onto unprimed cold-rolled steel panels with a 7-mil (18 μm) gap square applicator blade, resulting in a 3.5 mil (9 μm) wet film and a final Dry Film Thickness (DFT) of 1.5 mil (38 microns) +/−0.1 mil (2.54 microns). The films were allowed to cure for 7 days, scribed with a sharp razor knife and placed in a Q-Fog corrosion tester set for ASTM G85 Annex 5 (2017) Prohesion testing. The test exposes panels to alternating 2-h repetitive cycles: 1-h fog consisting of 0.05% sodium chloride and 0.35% ammonium sulfate with exposure zone temperature at ambient room temperature of 24+/−3° C. (75+/−6° F.) and 1-h dry off at 35+/−2° C. (95+/−3° F.). The dry off temperature must reach and remain at 35+/−2° C. (95+/−3° F.) within 3/4-h of switching from spray. The dry off is achieved by purging with fresh air such that within 3/4-h all visible moisture is dried off the specimens. The panels are evaluated by visual examination at regular intervals.

### Corrosion Resistance (Salt Fog Cabinet Test)

Salt fog cabinet test was conducted in accordance with ASTM B117. Films were cast onto unprimed cold-rolled steel panels with a 7-mil (18 μm) gap square applicator blade, resulting in a 3.5 mil (9 μm) wet film and a final Dry Film Thickness (DFT) of 1.5 mil (38 microns) +/−0.1 mil (2.54 microns). The films were cured for 7 days, scribed with a sharp razor knife and placed in a Q-Fog corrosion tester set for ASTM B117 (2017) testing. The panels are evaluated by visual examination at regular intervals.

### Amount of VOC in Coating Compositions

“VOC” is an abbreviation for volatile organic compound, which is defined as any volatile compound of carbon, excluding methane, carbon monoxide, carbon dioxide, carbonic acid, metallic carbides or carbonates, ammonium carbonate, and exempt compounds according to the Environmental Protection Agency and under, for example, 40 Code of Federal Regulations) 51.100(s). The VOC is calculated based on the Weight of Volatile Organic Content per gallon of material without water, and is reported, for example, as grams VOC per liter (g/L).

VOC was calculated using the following formula:

$$VOC Content = \frac{( Ws - Ww - Wec )}{( Vm - Vw - Vec )}$$

Where:
VOC Content=grams of volatile organic compounds per liter of coating
Ws=weight of volatiles, in grams
Ww=weight of water, in grams
Wec=weight of exempt compounds, in grams
Vm=volume of coating, in liters
Vw=volume of water, in liters
Vec=volume of exempt compounds, in liters

### Minimum Film Forming Temperature (MFFT)

MFFT measurement using ASTM D2354-10: The minimum film formation temperature (MFFT) of example latexes was analyzed on a rectangular temperature gradient bar. The MFFT was determined at the point where the latex formed a clear and uncracked dry film.

Adhesion: Scale of 0-5 wherein 5 is best.

The adhesion of the coating compositions was tested according to ASTM D-3359 (2017), method B (crosshatch adhesion). The coating compositions were applied with a film applicator to unprimed substrate panels with a wet coating thickness of about 3.5 mils (90 microns), resulting in a DFT of 1.5 mil (38 microns) +/−0.1 mil (2.5 microns). The films were dried in a climate-controlled room (50% Relative Humidity and 23° C.) for 1 and 7 days before testing adhesion. The films were scribed with a sharp razor knife in a 5 square×5 square grid, being sure to cut through to the substrate. The dry adhesion was tested with the ASTM-specified tape, removing the tape in the manner described in the ASTM. Wet adhesion was conducted by soaking the crosshatch area with a wet paper towel for 20 minutes, blotted dry, and then allowed to recover for 30 minutes. After this time the film was tested in the same manner as the dry adhesion test. The adhesion was then visually rated on a scale of 0 to 5, with a 0 rating being complete film removal and 5 being 100% film adhesion. Accordingly, 5 is the best adhesion, and an adhesion rating of 4 is acceptable.

### Konig Hardness

Konig pendulum hardness of coating films was measured following ASTM 4366 (2016). The paint films were prepared on 3 inch by 12 inch (7.6 cm by 30.5 cm) glass plates using a 10-mil (254 μm) drawdown bar and allowed to dry for 7 days. The dry film thickness was approximately 4 mils (100 μm). The Konig pendulum resting on the coating surface was set into oscillation (rocking) and the time in seconds for the swing amplitude of the pendulum to decrease from 6 inches (15.2 cm) to 3 inches (7.6 cm) was recorded.

The Konig hardness is measured in seconds. The results can be in the range of 0-150 second, and higher number means higher hardness, which is desirable. A Konig hardness for low VOC applications may be in the range of 8-30 seconds.

### EXAMPLES

### General Preparation of Multi-Stage Particles According to the Invention

The following steps were performed as a multi-stage emulsion polymerization.
1. Added emulsifier mix to reactor, heat to 85° C.
2. Prepared soft stage monomer mixture; mix for 10 min.
3. Prepared oxidizer/catalyst feed.
4. With reactor at 84-86° C., added initial monomer feed of a portion of soft stage monomer mixture; within 5 min, added initial oxidizer at temp 81-85° C.
5. Began soft stage monomer mixture feed, oxidizer/catalyst feeds after peak of exotherm, around 90° C.
6. Fed oxidizer/catalyst over 240 min.
7. At same time as oxidizer/catalyst/ fed soft stage monomer mixture feed over 76 min; stopped feed for 45 min. Let the temp drop from 90 to 85° C. gradually during this hold.
8. Prepared hard stage monomer mixture during the hold.
9. Fed hard stage monomer mixture over 104 min. around 85° C. Kept temp at 85° C. during the feed.
10. Cooled to 30° C., adjusted the pH to 9.5.

Tables 1 and 2 show the compositions of the soft stage polymers and the hard stage polymers for Examples 1-14.

TABLE 1
Examples 1-7 Formulations

| | | | | | | | | |
|---|---|---|---|---|---|---|---|---|
| EXAMPLE | 1 | 2 | 3 | 4 | 5 | 6 | 7 | 8 |

Soft Stage

| | | | | | | | | |
|---|---|---|---|---|---|---|---|---|
| Tg, ° C., Fox | −19.9 | −19.9 | −19.9 | −25.2 | −19.9 | −19.9 | −15.0 | −25.2 |
| Soft stage wt. fraction | 0.55 | 0.45 | 0.45 | 0.50 | 0.50 | 0.60 | 0.60 | 0.45 |
| Phosphate ester of | 1.80 | 1.80 | 1.80 | 1.80 | 1.80 | 1.80 | 1.80 | 1.80 |
| polypropylene glycol | | | | | | | | |
| monomethacrylate, | | | | | | | | |
| ammonium salt, wt % | | | | | | | | |
| Styrene, wt % | 31.00 | 31.00 | 31.00 | 27.00 | 31.00 | 31.00 | 34.50 | 27.00 |
| 2-ethylhexyl acrylate, | 58.70 | 58.70 | 58.70 | 62.70 | 58.70 | 58.70 | 55.20 | 62.70 |
| wt % | | | | | | | | |
| Methyl methacrylate, | 4.00 | 4.00 | 4.00 | 4.00 | 4.00 | 4.00 | 4.00 | 4.00 |
| wt % | | | | | | | | |
| Acetoacetoxyethyl | 3.50 | 3.50 | 3.50 | 3.50 | 3.50 | 3.50 | 3.50 | 3.50 |
| Methacrylate, wt % | | | | | | | | |
| Acrylamide, wt % | 1.00 | 1.00 | 1.00 | 1.00 | 1.00 | 1.00 | 1.00 | 1.00 |

Hard Stage

| | | | | | | | | |
|---|---|---|---|---|---|---|---|---|
| Tg, ° C., Fox | 60.0 | 50.2 | 60.0 | 70.0 | 60.0 | 50.2 | 39.4 | 70.2 |
| Hard stage wt. fraction | 0.45 | 0.55 | 0.55 | 0.50 | 0.50 | 0.40 | 0.40 | 0.55 |
| Phosphate ester of | 1.80 | 1.80 | 1.80 | 1.80 | 1.80 | 1.80 | 1.80 | 1.80 |
| polypropylene glycol | | | | | | | | |
| monomethacrylate, | | | | | | | | |
| ammonium salt, wt % | | | | | | | | |
| Styrene | 60.30 | 56.00 | 60.30 | 64.40 | 60.30 | 56.00 | 51.00 | 64.50 |
| 2-ethylhexyl acrylate, | 14.40 | 18.70 | 14.40 | 10.30 | 14.40 | 18.70 | 23.70 | 10.20 |
| wt % | | | | | | | | |
| Methyl methacrylate, | 19.00 | 19.00 | 19.00 | 19.00 | 19.00 | 19.00 | 19.00 | 19.00 |
| wt % | | | | | | | | |
| Acetoacetoxyethyl | 3.50 | 3.50 | 3.50 | 3.50 | 3.50 | 3.50 | 3.50 | 3.50 |
| Methacrylate, wt % | | | | | | | | |
| Acrylamide, wt % | 1.00 | 1.00 | 1.00 | 1.00 | 1.00 | 1.00 | 1.00 | 1.00 |

TABLE 2
Examples 8-14 Formulations

| EXAMPLE | 9 | 10 | 11 | 12 | 13 | 14 | 15 | 16 |
|---|---|---|---|---|---|---|---|---|
| Tg, ° C., Fox | −19.9 | −19.9 | −19.9 | −19.9 | −19.9 | −19.9 | −5 | −8 |
| Soft stage wt. fraction | 0.55 | 0.55 | 0.60 | 0.60 | 0.55 | 0.55 | 0.75 | 0.75 |
| Phosphate ester of | 1.80 | 1.80 | 1.80 | 1.80 | 1.80 | 1.80 | 1.8 | 1.8 |
| polypropylene glycol | | | | | | | | |
| monomethacrylate, | | | | | | | | |
| ammonium salt, wt % | | | | | | | | |
| Styrene, wt % | 31.00 | 31.00 | 31.00 | 31.00 | 31.00 | 31.00 | 43 | 41 |
| 2-ethylhexyl acrylate, | 58.70 | 58.70 | 58.70 | 58.70 | 58.70 | 58.70 | 47.7 | 49.7 |
| wt % | | | | | | | | |
| Methyl methacrylate, | 4.00 | 4.00 | 4.00 | 4.00 | 4.00 | 4.00 | 4 | 4 |
| wt % | | | | | | | | |
| Acetoacetoxyethyl | 3.50 | 3.50 | 3.50 | 3.50 | 3.50 | 3.50 | 3.5 | 3.5 |
| Methacrylate, wt % | | | | | | | | |
| Acrylamide, wt % | 1.00 | 1.00 | 1.00 | 1.00 | 1.00 | 1.00 | 0 | 0 |
| Tg, ° C., Fox | 40.0 | 50.2 | 60.0 | 70.2 | 60.0 | 70.2 | 40 | 50 |
| Hard stage wt. fraction | 0.45 | 0.45 | 0.40 | 0.40 | 0.45 | 0.45 | 0.25 | 0.25 |
| Phosphate ester of | 1.80 | 1.80 | 1.80 | 1.80 | 1.80 | 1.80 | 1.8 | 1.8 |
| polypropylene glycol | | | | | | | | |
| monomethacrylate, | | | | | | | | |
| ammonium salt, wt % | | | | | | | | |
| Styrene, wt % | 51.25 | 56.00 | 60.30 | 64.50 | 60.30 | 64.50 | 53 | 57 |
| 2-ethylhexyl acrylate, | 23.45 | 18.70 | 14.40 | 10.20 | 14.40 | 10.20 | 21.7 | 17.5 |
| wt % | | | | | | | | |
| Methyl methacrylate | 19.00 | 19.00 | 19.00 | 19.00 | 19.00 | 19.00 | 20 | 20 |
| Acetoacetoxyethyl | 3.50 | 3.50 | 3.50 | 3.50 | 3.50 | 3.50 | 3.5 | 3.5 |
| Methacrylate, wt % | | | | | | | | |
| Acrylamide, wt % | 1.00 | 1.00 | 1.00 | 1.00 | 1.00 | 1.00 | 0 | 0 |

Table 3 shows the Fox Equation theoretical Tg's and the weight ratios of the soft stage/hard stage of Examples 1-14.

TABLE 3
Fox Equation theoretical Tg's and the weight ratios of the soft stage/hard stage

| | | weight ratios of soft stage/hard stage | | | | |
|---|---|---|---|---|---|---|
| Tg soft | Tg hard | 75/25 | 60/40 | 55/45 | 50/50 | 45/55 |
| −5 | 40 | Example 15 | | | | |
| −8 | 50 | Example 16 | | | | |
| −20 | 40 | | Example 7 | Example 9 | | |
| −20 | 50 | | Example 6 | Example 10 | | Example 2 |
| −20 | 60 | | Example 11 | Examples 1, 13 | Example 5 | Example 3 |
| −20 | 70 | | Example 12 | Example 14 | Example 4 | Example 8 |

### General Preparation of Single-Stage Particles for Comparative Examples A and B

The following steps were performed as a single-stage emulsion polymerization. To prepared comparative Examples A and B.
1. Added emulsifier mix to reactor, heat to 83° C.
2. Prepared monomer mixture; mix for 10 min.
3. Prepared oxidizer/catalyst feed.
4. With reactor at 79-83° C., added initial oxidizer/catalyst.
5. Began single stage monomer mixture feed, oxidizer/catalyst feeds after peak of exotherm, around 90° C.
6. Fed oxidizer/catalyst over 240 min.
7. At same time as oxidizer/catalyst feed, fed single stage monomer mixture feed over 225 min;
8. Lowered temperature to 70° C.
9. Held for 45 minutes; cooled.

Table 4 shows the formulations for the Comparative Examples A and B.

TABLE 4
Single Stage Comparative Examples Formulations

| Comparative EXAMPLE | A | B |
|---|---|---|
| Tg, ° C., Fox | 4.5 | 10.0 |
| Phosphate ester of | 1.80 | 1.98 |
| polypropylene glycol | | |
| monomethacrylate, | | |
| ammonium salt, wt % | | |
| Styrene, wt % | 48.5 | 51.97 |
| 2-ethylhexyl acrylate, wt % | 42.2 | 39.96 |
| Methyl methacrylate, wt % | 4.0 | 4.13 |
| Acetoacetoxyethyl | 3.5 | 1.96 |
| Methacrylate, wt % | | |

### Performance Testing in an Example Coating Composition

The above mentioned resins were formulated into white paint following the formulation shown in Table 5. The VOC content of all of the coating compositions was 50 g/L.

TABLE 5
Gloss white coating formulation.

| | | | |
|---|---|---|---|
| Water - Grind | 80.9 | P:B by Weight | 10.7 |
| Disperbyk 190 | 14.28 | PVC | 16.20% |
| Surfynol 104BC | 4.76 | VOC, #/gal | 0.42 |
| BYK 024 | 0.95 | VOC, g/l | 50.07 |
| 28% Ammonia | 2.19 | NV, Weight | 52.20% |
| TiPure R-706 | 214.15 | NV, Volume | 41.20% |
| Aquaflow NHS 300 | 4.76 | WPG, lbs. | 10.2 |
| Coapur XS 71 | 1.9 | | |
| Resin | 634.52 | | |
| Butyl Cellosolve | 15.85 | | |
| Water | 26.65 | | |
| BYK 024 | 1.9 | | |
| Acticide MBS | 1.9 | | |
| Sodium Nitrite 15% | 10.28 | | |
| 28% Ammonia | 4.76 | | |
| Total | 1019.76 | | |

The Konig hardness, adhesion to certain substrates and the block resistance after 1 day and after 7 days of cure are shown in Table 6.

TABLE 6
Paint performance testing results

| Multi- | | | | | | | | |
|---|---|---|---|---|---|---|---|---|
| stage | | | | | | | | |
| particles | | | | | | | | |
| included | Comp. | Exam. | Exam. | Exam. | Exam. | Exam | Exam | Exam. |
| in paint | A | 14 | 13 | 12 | 11 | 10 | 15 | 16 |

Konig Hardness

| | | | | | | | | |
|---|---|---|---|---|---|---|---|---|
| 1 day | 7 | 11 | 10 | 8 | 8 | 9 | 8 | 6 |
| 7 day | 13 | 15 | 14 | 11 | 11 | 12 | 14 | 11 |

Adhesion - 1 day “B”
Cold-Rolled Steel

| | | | | | | | | |
|---|---|---|---|---|---|---|---|---|
| Dry | 5 | 4 | 4 | 4 | 4 | 4 | 5 | 5 |
| Wet | 5 | 4 | 4 | 4 | 4 | 4 | 5 | 5 |

Untreated Aluminum

| | | | | | | | | |
|---|---|---|---|---|---|---|---|---|
| Dry | 5 | 4 | 4 | 4 | 4 | 4 | 5 | 5 |
| Wet | 5 | 4 | 4 | 4 | 4 | 4 | 5 | 5 |

Hot Dip galvanized

| | | | | | | | | |
|---|---|---|---|---|---|---|---|---|
| Dry | 5 | 4 | 4 | 4 | 4 | 4 | 5 | 5 |
| Wet | 5 | 3 | 3 | 3 | 2 | 4 | 5 | 5 |

Block Resistance - 1 day cure

| | | | | | | | | |
|---|---|---|---|---|---|---|---|---|
| 24 hours | 0 | 6 | 5 | 4 | 4 | 1 | 6 | 2 |
| at 25° C. | | | | | | | | |
| 1 hour at | 0 | 3 | 2 | 2 | 0 | 5 | 5 | 3 |
| 120° F. | | | | | | | | |

Block Resistance - 7 day cure

| | | | | | | | | |
|---|---|---|---|---|---|---|---|---|
| 24 hours | 1 | 7 | 7 | 6 | 5 | 5 | 8 | 7 |
| at 25° C. | | | | | | | | |
| 1 hour at | 0 | 5 | 5 | 4 | 4 | 5 | 6 | 6 |
| 120° F. | | | | | | | | |

As can be seen in Table 6, the coating compositions made with the inventive multi-stage polymeric particles had much better block resistance and had a similar Konig hardness as the coating compositions made with the Comparative Example A single-stage polymeric particles. The highest rating for adhesion test was 5. The one stage comparative sample rating is 5, but this sample did not provide good block resistance. For the inventive two stage system, the adhesion test rating was 4 to 5, which is pretty good, and these samples had good block resistance. Although not shown, many of the commercial samples provided poor adhesion, some having an adhesion rating as low as 0 depending on the testing substrate.

Humidity resistance testing was tested in accordance with ASTM D4585 as described above. The coating compositions prepared with certain of the Example multi-stage particles were compared to the same coating compositions, but prepared with Comparative Examples A, as well as a commercial paint. The results are shown in the FIG. 1, where it can be seen that the coating compositions prepared with the multi-stage particles performed much better in this humidity resistance test than the single-stage particles and the commercial paint composition.

Corrosion resistance testing was conducted in accordance with ASTM G85 Annex 5. Some of the coating compositions prepared with certain of the Example multi-stage particles were compared to the same coating compositions, but prepared with Comparative Examples A and B, as well as a commercial paint. The results are shown in the FIG. 2, where it can be seen that the coating compositions prepared with the multi-stage particles performed much better in this corrosion test than the single-stage particles and are comparable or better than the commercial paint composition. Corrosion resistance testing was also conducted in accordance with ASTM B117, the results are shown in FIG. 3. Commercial paint A (VOC: 50g/L) gave the best salt fog corrosion resistance result, but it needed fluoro surfactant to boost its block resistance; Commercial paint B has the highest VOC (150 g/L). Although commercial paint B, one stage Comp. A, Example 15 and 16 all have the similar corrosion resistance, example 15 and 16 have the best block resistance rating.

1. Polymeric multi-stage particles comprising:
a) a first-formed soft stage comprising a first polymer, wherein the first polymer comprises, as polymerized units based on the dry weight of the first polymer:
i) one or more free radical polymerizable ethylenically unsaturated monomers;
ii) 0 to 3 wt % of a free radical polymerizable surfactant monomer;
iii) 0 to 4 wt % of a free radical polymerizable monomer having a beta dicarbonyl functionality;
iv) 0 to 2 wt % of a monomer selected from the group consisting of acrylamide, diacetone acrylamide, 2-hydroxyethyl (meth)acrylate, hydroxypropyl (meth)acrylates, and hydroxybutyl (meth)acrylates, glycidyl methacrylate, 3-(methacryloyloxy)propyltrimethoxysilane, vinyltrimethoxysilane, and mixtures thereof;
v) 0.1 to 1.9 wt % of a free radical polymerizable monomer containing phosphorus acid or salt thereof;
vi) 0-1.9 wt % of a free radical polymerizable polyethylenically unsaturated monomers; and
less than 0.1 wt % of other acid-containing free-radical polymerizable monomers;
b) a second-formed hard stage comprising a second polymer, wherein the second polymer comprises, as polymerized units based on the dry weight of the second polymer,
vii) one or more free radical polymerizable ethylenically unsaturated monomers,
viii) 0 to 3 wt % of a free radical polymerizable surfactant monomer;
ix) 0 to 4 wt % of a free radical polymerizable monomer having a beta dicarbonyl functionality;
x) 0 to 2 wt % of a monomer selected from the group consisting of acrylamide, diacetone acrylamide, 2-hydroxyethyl (meth)acrylate, hydroxypropyl (meth)acrylates, and hydroxybutyl (meth)acrylates, glycidyl methacrylate, 3-(methacryloyloxy)propyltrimethoxysilane, vinyltrimethoxysilane, and mixtures thereof;
xi) 0.1 to 5% of a free radical polymerizable monomer containing phosphorus acid or salt thereof, preferably 0.1 to 4% a free radical polymerizable monomer containing phosphorus acid or salt thereof, more preferably 0.1 to 1.9 wt % of a free radical polymerizable monomer containing phosphorus acid or salt thereof;
xii) 0-1.9 wt % of a free radical polymerizable polyethylenically unsaturated monomers; and and
less than 0.1 wt % of other acid-containing free-radical polymerizable monomers;
wherein:
the first polymer has a theoretical Fox equation Tg of from 5 to −50° C.;
the second polymer has a theoretical Fox equation Tg of from 30° C. to 100° C.; and
the particles comprise, on a dry weight basis: 10 wt % to 90 wt % of the first polymer, and 90 wt % to 10 wt % of the second polymer.

2. The polymeric particles of claim 1, wherein the particles have two separate Tg's as measured by differential scanning calorimetry.

3. The polymeric particles of claim 1, wherein the i) one or more free radical polymerizable ethylenically unsaturated monomers in the first polymer are selected from the group consisting of one or more alkyl(meth)acrylates, styrene, and mixtures thereof.

4. The polymeric particles of claim 1, wherein the vii) one or more free radical polymerizable ethylenically unsaturated monomers in the second polymer are selected from the group consisting of one or more alkyl(meth)acrylates, styrene, and mixtures thereof.

5. The polymeric particles of claim 1, wherein the v) 0.1 to 1.9 wt % of a free radical polymerizable monomer containing phosphorus acid or salt thereof in the first polymer is selected from a monomer corresponding to the formula I and mixtures thereof:
CH₂═C(R¹)—C(═O)—O—[X—O]ₙ—P(═O)(OY)₂ (I)
where R¹ is H or CH₃, each X is independently —(CH2)₂—, —CH₂CH(CH₃)—, —CH(CH₃)CH₂—, —(CH₂)₂—O—CH₂CH(CH₃)—, or —(CH₂)₂—O—CH(CH₃)CH₂—, or mixtures thereof, and each Y is independently H, ammonium, or an alkali metal, and n is an integer from 1 to 30.

6. The polymeric particles of claim 1, wherein the xi) free radical polymerizable monomer containing phosphorus acid or salt thereof in the second polymer is selected from a monomer corresponding to the formula I and mixtures thereof:
CH₂═C(R¹)—C(═O)—O—[X—O]ₙ—P(═O)(OY)₂ (I)
where R¹ is H or CH₃, each X is independently —(CH₂)₂—, —CH₂CH(CH₃)—, —CH(CH₃)CH₂—, —(CH₂)₂—O—CH₂CH(CH₃)—, or —(CH₂)₂—O—CH(CH₃)CH₂— or mixtures thereof, each Y is independently H, ammonium, or an alkali metal, and n is an integer from 1 to 30

7. The polymeric particles of claim 1, comprising up to 3 wt % of the ii) free radical polymerizable surfactant monomer in the first polymer selected from monomers according to Formulas II, III, IV, where Formula II is: 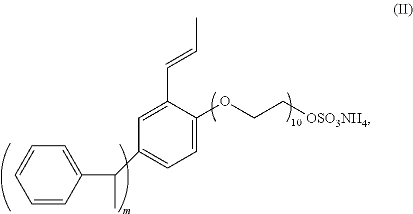
where m is an integer from 1 to 30,
Formula III is: 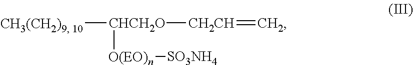
where n is an integer from 1 to 30,
and Formula IV is: 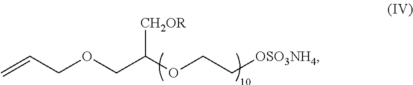
where R is a branched C10 alkyl group or bicycloheptane,
and mixtures thereof.

8. The polymeric particles of claim 1, comprising up to 3 wt % of the viii) free radical polymerizable surfactant monomer in the second polymer selected from monomers according to Formulas II, III, IV,
wherein Formula II is: 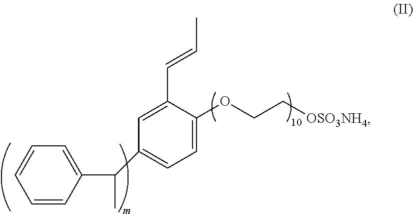
where m is an integer from 1 to 30,
Formula III is: 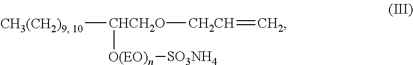
where n is an integer from 1 to 30,
Formula IV is: 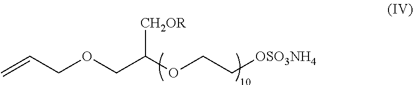
where R is a branched C10 alkyl group or bicycloheptane,
and mixtures thereof.

9. The polymeric particles of claim 1, comprising from 0.01 to 4 wt % of the iii) free radical polymerizable monomer having a beta dicarbonyl functionality in the first polymer selected from the group consisting of acetoacetoxyalkyl(meth)acrylate, 2-acetoacetoxyethyl (meth)acrylate, 3-acetoacetoxypropyl (meth)acrylate, 4-acetoacetoxybutyl (meth)acrylate, 2-cyanoacetoxyethyl (meth)acrylate, 3-cyanoacetoxypropyl (meth)acrylate, 4-cyanoacetoxybutyl (meth)acrylate, N-(2-acetoacetoxyethyl) (meth)acrylamide, allyl acetoacetate, 2,3-di(acetoacetoxy)propyl (meth)acrylate, vinyl acetoacetate, and combinations thereof.

10. The polymeric particles of claim 1, comprising from 0.01 to 4 wt % of the ix) free radical polymerizable monomer having a beta dicarbonyl functionality in the second polymer selected from the group consisting of acetoacetoxyalkyl(meth)acrylate, 2-acetoacetoxyethyl (meth)acrylate, 3-acetoacetoxypropyl (meth)acrylate, 4-acetoacetoxybutyl (meth)acrylate, 2-cyanoacetoxyethyl (meth)acrylate, 3-cyanoacetoxypropyl (meth)acrylate, 4-cyanoacetoxybutyl (meth)acrylate, N-(2-acetoacetoxyethyl) (meth)acrylamide, allyl acetoacetate, 2,3-di(acetoacetoxy)propyl (meth)acrylate, vinyl acetoacetate, and combinations thereof.

11. The polymeric particles of claim 1, wherein the first polymer comprises from 0.01 wt % to 2 wt % of iv) acrylamide, diacetone acrylamide, 2-hydroxyethyl (meth)acrylate, hydroxypropyl (meth)acrylates, and hydroxybutyl (meth)acrylates, glycidyl methacrylate, 3-(methacryloyloxy)propyltrimethoxysilane, vinyltrimethoxysilane, and mixtures thereof.

12. The polymeric particles of claim 1, wherein the second polymer comprises from 0.01 wt % to 2 wt % of x) acrylamide, diacetone acrylamide, 2-hydroxyethyl (meth)acrylate, hydroxypropyl (meth)acrylates, and hydroxybutyl (meth)acrylates, glycidyl methacrylate, 3-(methacryloyloxy)propyltrimethoxysilane, vinyltrimethoxysilane, and mixtures thereof.

13. A method for forming polymeric particles, wherein the method comprises the steps of:
combining:
i) one or more free radical polymerizable ethylenically unsaturated monomers;
ii) 0 to 3 wt % of a free radical polymerizable surfactant monomer;
iii) 0 to 4 wt % of a free radical polymerizable monomer having a beta dicarbonyl functionality;
iv) 0 to 2 wt % of a monomer selected from the group consisting of acrylamide, diacetone acrylamide, 2-hydroxyethyl (meth)acrylate, hydroxypropyl (meth)acrylates, and hydroxybutyl (meth)acrylates, glycidyl methacrylate, 3-(methacryloyloxy)propyltrimethoxysilane, vinyltrimethoxysilane, and mixtures thereof;
v) 0.1 to 1.9 wt % of a free radical polymerizable monomer containing phosphorus acid or salt thereof;
vi) 0-1.9 wt % of a free radical polymerizable polyethylenically unsaturated monomers; and
less than 0.1 wt % of other acid-containing free-radical polymerizable monomers;
to form a first monomer mixture;
combining:
vii) one or more free radical polymerizable ethylenically unsaturated monomers;
viii) 0 to 3 wt % of a free radical polymerizable surfactant monomer;
ix) 0 to 4 wt % of a free radical polymerizable monomer having a beta dicarbonyl functionality;
x) 0 to 2 wt % of a monomer selected from the group consisting of acrylamide, diacetone acrylamide, 2-hydroxyethyl (meth)acrylate, hydroxypropyl (meth)acrylates, and hydroxybutyl (meth)acrylates and mixtures thereof;
xi) 0.1 to 5% of a free radical polymerizable monomer containing phosphorus acid, preferably 0.1 to 4% a free radical polymerizable monomer containing phosphorus acid or salt thereof, more preferably 0.1 to 1.9 wt % of a free radical polymerizable monomer containing phosphorus acid or salt thereof;
xii) 0-1.9 wt % of a free radical polymerizable polyethylenically unsaturated monomers; and
less than 0.1 wt % of other acid-containing free-radical polymerizable monomers,
to form a second monomer mixture;
wherein the second monomer mixture differs from the first monomer mixture in at least one of type or relative amount of polymerizable ethylenically unsaturated monomer, and wherein the weight of the first monomer mixture is from 10% to 90% of the total weight of the first monomer mixture and the second monomer mixture and the weight of the second monomer mixture is from 90% to 10% of the total weight of the first monomer mixture and the second monomer mixture;
feeding the first monomer mixture to a reactor vessel;
initiating a free radical polymerization, at a pH of from 2 to 9, preferably from 2 to 8, more preferably 2 to 7, of the first monomer mixture to form a first stage of the polymeric particles, the first-formed stage comprising a first polymer comprising the first monomer mixture as polymerized units;
feeding the second monomer mixture to the reactor vessel;
polymerizing, at a pH of from 2 to 9, preferably from 2 to 8, more preferably from 2 to 7, the second monomer mixture in the presence of the first-formed stage to form a second stage of the polymeric particles, the second stage comprising a second polymer comprising the second monomer mixture as polymerized units;
wherein:
the polymeric particles comprise the first polymer and the second polymer;
the first polymer has a theoretical Fox equation Tg of from −50° C. to 5° C.;
the second polymer has a theoretical Fox equation Tg of from 30° C. to 100° C.

14. The method of claim 13, wherein the particles have two separate Tg's as measured by differential scanning calorimetry.

15. The method of claim 13, wherein the i) one or more free radical polymerizable ethylenically unsaturated monomers in the first polymer are selected from the group consisting of one or more alkyl(meth)acrylates, styrene, and mixtures thereof.

16. The method of claim 13, wherein the vii) one or more free radical polymerizable ethylenically unsaturated monomers in the second polymer are selected from the group consisting of one or more alkyl(meth)acrylates, styrene, and mixtures thereof.

17. The method of claim 13, wherein the v) 0.1 to 1.9 wt % of a free radical polymerizable monomer containing phosphorus acid or salt thereof in the first polymer is selected from a monomer corresponding to the formula I and mixtures thereof:
CH₂═C(R¹)—C(═O)—O—[X—O]ₙ—P(═O)(OY)₂ (I)
where R¹ is H or CH₃, each X is independently —(CH₂)₂—, —CH₂CH(CH₃)—, —CH(CH₃)CH₂—, —(CH₂)₂—O—CH₂CH(CH₃)—, or —(CH₂)₂—O—CH(CH₃)CH₂— or mixtures thereof, each Y is independently H, ammonium, or an alkali metal, and n is an integer from 1 to 30.

18. The method of claim 13, wherein the xi) free radical polymerizable monomer containing phosphorus acid or salt thereof in the second polymer is selected from a monomer corresponding to the formula I and mixtures thereof:
CH₂═C(R¹)—C(═O)—O—[X—O]ₙ—P(═O)(OY)₂ (I)
where R¹ is H or CH₃, each X is independently —(CH₂)₂—, —CH₂CH(CH₃)—, —CH(CH₃)CH₂—, —(CH₂)₂—O—CH₂CH(CH₃)—, or —(CH₂)₂—O—CH(CH₃)CH₂— or mixtures thereof, each Y is independently H, ammonium, or an alkali metal, and n is an integer from 1 to 30.

19. The method of claim 13, comprising from up to 3 wt % of the ii) free radical polymerizable surfactant monomer in the first polymer selected from monomers according to Formulas II, III, or IV
wherein Formula II is: 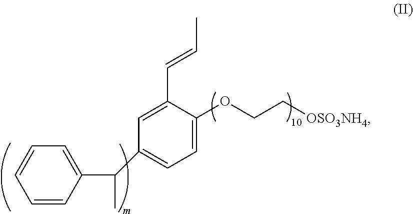
where m is an integer from 1 to 30,
Formula III is: 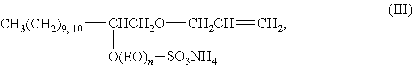
where n is an integer from 1 to 30,
Formula IV is: 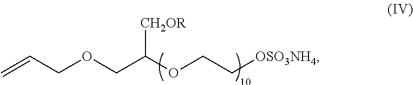
where R is a branched C10 alkyl group or bicycloheptane,
and mixtures thereof.

20. The method of claim 13, comprising up to 3 wt % of the viii) free radical polymerizable surfactant monomer in the second polymer selected from monomers according to Formulas II, III, IV,
wherein Formula II is: 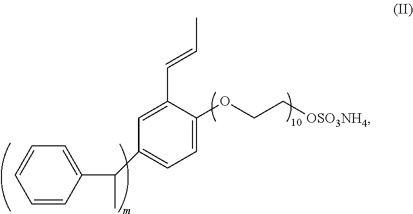
where m is an integer from 1 to 30,
Formula III is: 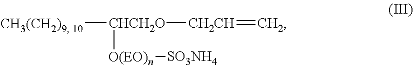
where n is an integer from 1 to 30,
Formula IV is: 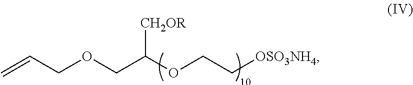
where R is a branched C10 alkyl group or bicycloheptane,
and mixtures thereof.

21. The method of claim 13, comprising from 0.01 to 4 wt % of the iii) free radical polymerizable monomer having a beta dicarbonyl functionality in the first polymer selected from the group consisting of acetoacetoxyalkyl(meth)acrylate, 2-acetoacetoxyethyl (meth)acrylate, 3-acetoacetoxypropyl (meth)acrylate, 4-acetoacetoxybutyl (meth)acrylate, 2-cyanoacetoxyethyl (meth)acrylate, 3-cyanoacetoxypropyl (meth)acrylate, 4-cyanoacetoxybutyl (meth)acrylate, N-(2-acetoacetoxyethyl) (meth)acrylamide, allyl acetoacetate, 2,3-di(acetoacetoxy)propyl (meth)acrylate, vinyl acetoacetate, and combinations thereof.

22. The method of claim 13, comprising from 0.01 to 4 wt % of the viii) free radical polymerizable monomer having a beta dicarbonyl functionality in the second polymer selected from the group consisting of acetoacetoxyalkyl(meth)acrylate, 2-acetoacetoxyethyl (meth)acrylate, 3-acetoacetoxypropyl (meth)acrylate, 4-acetoacetoxybutyl (meth)acrylate, 2-cyanoacetoxyethyl (meth)acrylate, 3-cyanoacetoxypropyl (meth)acrylate, 4-cyanoacetoxybutyl (meth)acrylate, N-(2-acetoacetoxyethyl) (meth)acrylamide, allyl acetoacetate, 2,3-di(acetoacetoxy)propyl (meth)acrylate, vinyl acetoacetate, and combinations thereof.

23. The method of claim 13, wherein the first polymer comprises from 0.01% to 2wt % of iv) acrylamide, diacetone acrylamide, 2-hydroxyethyl (meth)acrylate, hydroxypropyl (meth)acrylates, and hydroxybutyl (meth)acrylates, glycidyl methacrylate, 3-(methacryloyloxy)propyltrimethoxysilane, vinyltrimethoxysilane, and mixtures thereof.

24. The method of claim 13, wherein the second polymer comprises from 0.01% to 2wt % of x) acrylamide, diacetone acrylamide, 2-hydroxyethyl (meth)acrylate, hydroxypropyl (meth)acrylates, and hydroxybutyl (meth)acrylates and mixtures thereof.

25. A coating composition comprising:
a coalescing agent; and
a waterborne emulsion comprising polymeric particles according to claim 1, wherein the coating composition has a volatile organic compound content of less than 50 grams per liter of the coating composition and the coating composition has a minimum film forming temperature of less 15° C.
